(19) United States
(12) Patent Application Publication
(10) Pub. No.: US 2026/0104154 A1
(43) Pub. Date: Apr. 16, 2026

(54) LIGHT ADJUSTMENT DEVICE

(71) Applicant: Japan Display Inc., Tokyo (JP)

(72) Inventors: Takeo KOITO, Tokyo (JP); Kojiro IKEDA, Tokyo (JP); Tae KUROKAWA, Tokyo (JP)

(21) Appl. No.: 19/336,984

(22) Filed: Sep. 23, 2025

(30) Foreign Application Priority Data
Oct. 10, 2024 (JP) 2024-177926

(51) Int. Cl. F21V 14/00

(52) U.S. Cl. CPC F21V 14/003

(57) ABSTRACT

According to an aspect, a light adjustment device includes: a panel unit including light adjustment panels; a light source; and a driver electrically coupled to each of the light adjustment panels and configured to control voltage applied to each of the light adjustment panels. Each of the light adjustment panels includes a first substrate provided with electrodes, a second substrate placed in the first direction so as to overlap the first substrate and provided with electrodes, and a liquid crystal layer filled between the first substrate and the second substrate. When one of voltage supplied to the electrodes provided on the first substrate and voltage supplied to the electrodes provided on the second substrate is a predetermined highest voltage, the other voltage is a voltage less than the predetermined highest voltage.

### CROSS-REFERENCE TO RELATED APPLICATION

This application claims the benefit of priority from Japanese Patent Application No. 2024-177926 filed on Oct. 10, 2024, the entire contents of which are incorporated herein by reference.

### BACKGROUND

### 1. Technical Field

What is disclosed herein relates to a light adjustment device.

### 2. Description of the Related Art

A light adjustment device disclosed in Japanese Patent Application Laid-open Publication No. 2010-230887 (JP-A-2010-230887) includes a light source and a panel unit. The panel unit includes a plurality of light adjustment panels stacked in the up-down direction. When incident light enters a light adjustment panel on the light source side in the panel unit, the light transmittance of the incident light is adjusted in the panel unit, and this adjusted transmission light is emitted from a light adjustment panel on the opposite side to the light source.

Each light adjustment panel includes a lower substrate, a drive electrode on the lower substrate side, an upper substrate, a drive electrode on the upper substrate side, and a liquid crystal layer. An equipotential electric field in a circular arc shape that is convex upward is generated when voltage is applied to the drive electrode on the lower substrate side, whereas an equipotential electric field in a circular arc shape that is convex downward is generated when voltage is applied to the drive electrode on the upper substrate side.

When voltage applied to the upper and lower drive electrodes is increased, the electric field positioned on the upper side and the electric field positioned on the lower side both become stronger, and accordingly, the upper and lower electric fields intersect each other at an intermediate part of the liquid crystal layer in the thickness direction. Accordingly, alignment disorder may occur to liquid crystal molecules disposed at the intermediate part of the liquid crystal layer in the thickness direction, thereby causing unintended diffusion and potentially leading to decrease in the illuminance of light emitted from the panel unit of the light adjustment device.

### SUMMARY

According to an aspect, a light adjustment device includes: a panel unit in which a plurality of light adjustment panels are stacked in a first direction; a light source disposed on one side in the first direction relative to the panel unit; and a driver electrically coupled to each of the light adjustment panels and configured to control voltage applied to each of the light adjustment panels. Each of the light adjustment panels provided in the panel unit includes a first substrate provided with electrodes, a second substrate placed in the first direction so as to overlap the first substrate and provided with electrodes, and a liquid crystal layer filled between the first substrate and the second substrate. When one of voltage supplied to the electrodes provided on the first substrate and voltage supplied to the electrodes provided on the second substrate is a predetermined highest voltage, the other voltage is a voltage less than the predetermined highest voltage.

According to an aspect, a light adjustment device includes: a panel unit in which a plurality of light adjustment panels are stacked in a first direction; a light source disposed on one side in the first direction relative to the panel unit; and a driver electrically coupled to each of the light adjustment panels and configured to control voltage applied to each of the light adjustment panels. Each of the light adjustment panels provided in the panel unit includes a first substrate provided with electrodes, a second substrate placed in the first direction so as to overlap the first substrate and provided with electrodes, and a liquid crystal layer filled between the first substrate and the second substrate. The light adjustment panels include a first-type light adjustment panel and a second-type light adjustment panel. In the first-type light adjustment panel, when one of voltage supplied to the electrodes provided on the first substrate and voltage supplied to the electrodes provided on the second substrate is a predetermined highest voltage, the other voltage is a voltage less than the predetermined highest voltage. In the second-type light adjustment panel, in a case where one of voltage supplied to the electrodes provided on the first substrate and voltage supplied to the electrodes provided on the second substrate is voltage corresponding to a predetermined high voltage range, the other voltage is voltage lower than a lower limit of the predetermined high voltage range.

### BRIEF DESCRIPTION OF THE DRAWINGS

FIG. 1 is a schematic diagram of each light adjustment panel according to a first embodiment when viewed from the upper side;

FIG. 2 is a plan view of a first substrate according to the first embodiment;

FIG. 3 is a plan view of a second substrate according to the first embodiment;

FIG. 4 is a plan view of each light adjustment panel obtained by placing the second substrate on the upper side of the first substrate;

FIG. 5 is a schematic diagram of four light adjustment panels constituting a light adjustment device according to the first embodiment;

FIG. 6 is a schematic diagram illustrating an arrangement of the four light adjustment panels in a panel unit;

FIG. 7 is a block diagram of the light adjustment device;

FIG. 8 is a schematic perspective view of each light adjustment panel, illustrating an arrangement of drive electrodes;

FIG. 9 is a sectional view of each light adjustment panel, illustrating the alignment state of liquid crystal molecules in a state in which no voltage is applied to the drive electrodes on the first substrate side;

FIG. 10 is a sectional view of each light adjustment panel, illustrating the alignment state of liquid crystal molecules when voltage is applied to the drive electrodes on the first substrate side;

FIG. 11 is a sectional view of each light adjustment panel, illustrating the alignment state of liquid crystal molecules when voltage is applied to the drive electrodes on the second substrate side;

FIG. 12 is a diagram illustrating voltage waveforms input to the drive electrodes of each light adjustment panel;

FIG. 13 is a schematic diagram illustrating a section of each light adjustment panel corresponding to FIG. 10, illustrating electric fields that are convex upward when voltage is applied to the drive electrodes on the first substrate side;

FIG. 14 is a schematic diagram illustrating a section of each light adjustment panel corresponding to FIG. 11, illustrating electric fields that are convex downward when voltage is applied to the drive electrodes on the second substrate side;

FIG. 15 is a diagram of each light adjustment panel when viewed from the upper side, illustrating the direction of an electric field at a central part of a liquid crystal layer in the thickness direction with arrows; and

FIG. 16 is a diagram illustrating voltage waveforms input to the drive electrodes of each light adjustment panel in a second embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

In an XYZ coordinate system illustrated in the drawings, an X direction is the right-left direction, and an X1 side is opposite an X2 side. The X1 side is also referred to as a left side, and the X2 side is also referred to as a right side. A Y direction is the front-back direction, and a Y1 side is opposite a Y2 side. The Y1 side is also referred to as a front side, and the Y2 side is also referred to as a back side. A Z direction is the up-down direction (stacking direction). A Z1 side is opposite a Z2 side. The Z1 side is also referred to as an upper side, and the Z2 side is also referred to as a lower side. The Z direction is also referred to as a first direction.

In this disclosure, when an element is described as being “on” another element, the element can be directly on the other element, or there can be one or more elements between the element and the other element.

### First Embodiment

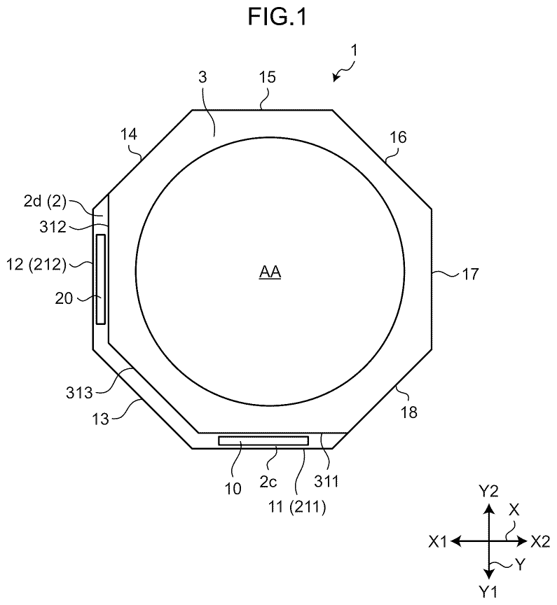

The following first describes each light adjustment panel 1 according to a first embodiment. FIG. 1 is a schematic diagram of each light adjustment panel according to the first embodiment when viewed from the upper side.

As illustrated in FIG. 1, each light adjustment panel 1 includes a first substrate 2 and a second substrate 3 disposed on the upper side (Z1 side) relative to the first substrate 2. Each light adjustment panel 1 is an octagon in plan view and has a first side 11, a second side 12, a third side 13, a fourth side 14, a fifth side 15, a sixth side 16, a seventh side 17, and an eighth side 18. In the present invention, the shape of each light adjustment panel 1 is not particularly limited, and polygons other than octagons as well as circles and ellipses are included in the present invention.

An end part 2c of the first substrate 2 on the Y1 side is exposed at a portion along the first side 11. A first terminal group 10 is provided at the end part 2c.

An end part 2d of the first substrate 2 on the X1 side is exposed at a portion along the second side 12. A second terminal group 20 is provided at the end part 2d. An active area AA is circular in plan view.

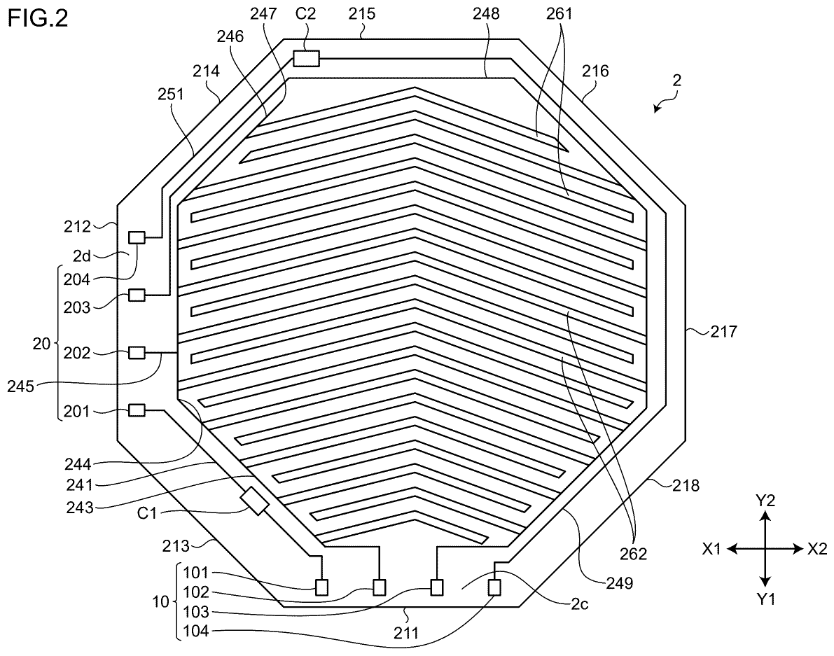

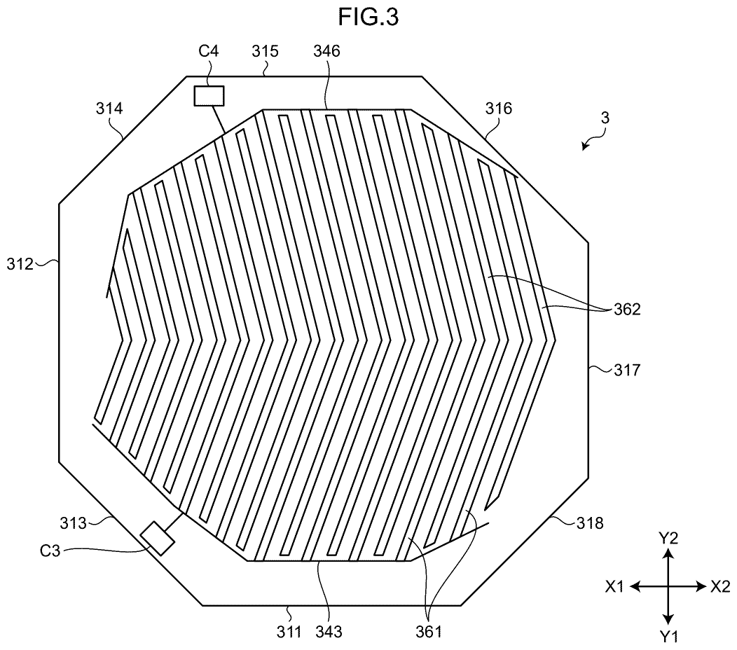

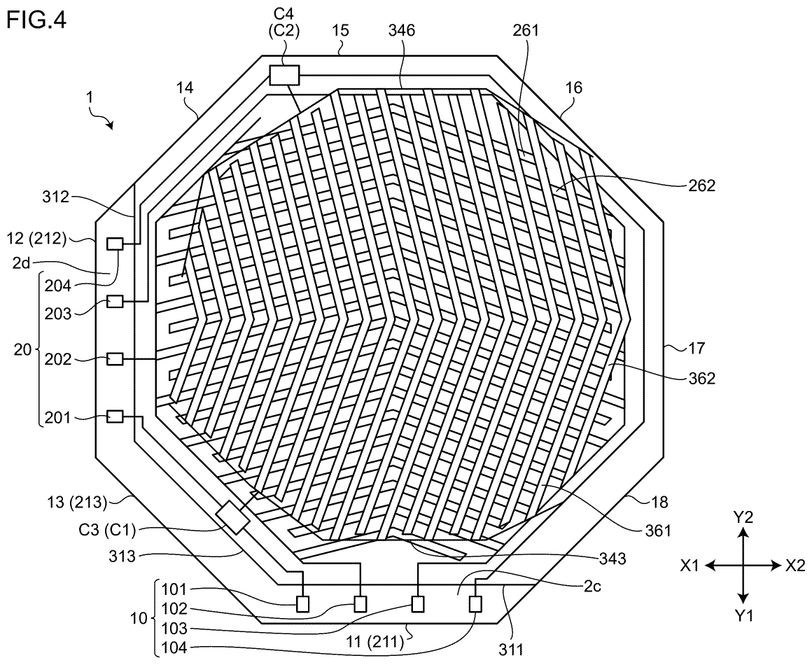

The following describes wiring on the first substrate 2 and the second substrate 3. FIG. 2 is a plan view of the first substrate according to the first embodiment. FIG. 3 is a plan view of the second substrate according to the first embodiment. FIG. 4 is a plan view of a light adjustment panel obtained by placing the second substrate on the upper side of the first substrate.

As illustrated in FIG. 2, wiring lines, drive electrodes, and coupling parts are provided on the first substrate 2. A coupling part C1 of the first substrate 2 and a coupling part C3 (refer to FIG. 3) of the second substrate 3 are electrically coupled to each other through a conductive bead (not illustrated). Similarly, a coupling part C2 of the first substrate 2 and a coupling part C4 (refer to FIG. 3) of the second substrate 3 are electrically coupled to each other through a conductive bead (not illustrated).

The first substrate 2 is an octagon in plan view and includes a first side 211, a second side 212, a third side 213, a fourth side 214, a fifth side 215, a sixth side 216, a seventh side 217, and an eighth side 218.

The first terminal group 10 includes a first terminal 101, a second terminal 102, a third terminal 103, and a fourth terminal 104. The first terminal 101, the second terminal 102, the third terminal 103, and the fourth terminal 104 are sequentially arranged in the X direction from the X1 side toward the X2 side.

The second terminal group 20 includes a fifth terminal 201, a sixth terminal 202, a seventh terminal 203, and an eighth terminal 204. The fifth terminal 201, the sixth terminal 202, the seventh terminal 203, and the eighth terminal 204 are sequentially arranged in the Y direction from the Y1 side toward the Y2 side.

The first terminal 101 and the fifth terminal 201 are electrically coupled to each other through a wiring line 241. The coupling part C1 is provided at an intermediate point of the wiring line 241.

The second terminal 102 and the sixth terminal 202 are electrically coupled to each other through wiring lines 243 and 245. A bifurcation point 244 is provided on the wiring line 243, and a wiring line 246 extends from the bifurcation point 244 to an end 247.

The third terminal 103 and the seventh terminal 203 are electrically coupled to each other through a wiring line 248. The fourth terminal 104 and the eighth terminal 204 are electrically coupled to each other through wiring lines 249 and 251. The coupling part C2 is provided between the wiring lines 249 and 251.

A plurality of drive electrodes (first drive electrodes) 261 are coupled to the wiring lines 243 and 246. A plurality of drive electrodes (second drive electrodes) 262 are coupled to the wiring line 248. The drive electrodes 261 are also referred to as first drive electrodes. The drive electrodes 262 are also referred to as second drive electrodes. The drive electrodes 261 and 262 both extend in the X direction. Specifically, the drive electrodes 261 and 262 bend in a V shape protruding toward the Y2 side. The drive electrodes 261 and 262 are alternately arranged in the Y direction. In this manner, electrodes provided on the first substrate 2 include the drive electrodes 261 and the drive electrodes 262 disposed adjacent to the drive electrodes 261.

As illustrated in FIG. 3, wiring lines, drive electrodes, and coupling parts are provided on the second substrate 3. The second substrate 3 is an octagon in plan view and has a first side 311, a second side 312, a third side 313, a fourth side 314, a fifth side 315, a sixth side 316, a seventh side 317, and an eighth side 318.

The coupling part C3 is coupled to a wiring line 343. The coupling part C4 is coupled to a wiring line 346. The wiring line 343 extends along the first side 311, the third side 313, and the eighth side 318. The wiring line 346 extends along the fourth side 314, the fifth side 315, and the sixth side 316.

A plurality of drive electrodes (third drive electrodes) 361 are coupled to the wiring line 343. A plurality of drive electrodes (fourth drive electrodes) 362 are coupled to the wiring line 346. The drive electrodes 361 are also referred to as third drive electrodes. The drive electrodes 362 are also referred to as fourth drive electrodes. The drive electrodes 361 and 362 both extend in the Y direction. Specifically, the drive electrodes 361 and 362 bend in a V shape protruding toward the X2 side. The drive electrodes 361 and 362 are alternately arranged in the X direction. In this manner, electrodes provided on the second substrate 3 include the drive electrodes 361 and the drive electrodes 362 disposed adjacent to the drive electrodes 361.

As illustrated in FIG. 4, in the light adjustment panel 1 obtained by placing the second substrate 3 in FIG. 3 on the upper side of the first substrate 2 in FIG. 2, the end parts 2c and 2d of the first substrate 2 are exposed.

In a state in which the second substrate 3 is placed on the upper side of the first substrate 2, the first side 311, the third side 313, and the second side 312 of the second substrate 3 are positioned on the inner side (at a central part in plan view) relative to the first side 211, the third side 213, and the second side 212 of the first substrate 2. In this manner, the area of the second substrate 3 is smaller than the area of the first substrate 2, and accordingly, in FIG. 4, the first terminal group 10 provided at the end part 2c of the first substrate 2 and the second terminal group 20 provided at the end part 2d thereof are exposed. The drive electrodes 361 and 362 are disposed so as to intersect the drive electrodes 261 and 262. The intersection angle between the drive electrodes 361 and 362 and the drive electrodes 261 and 262 is, for example, 80° or more and 100° or less.

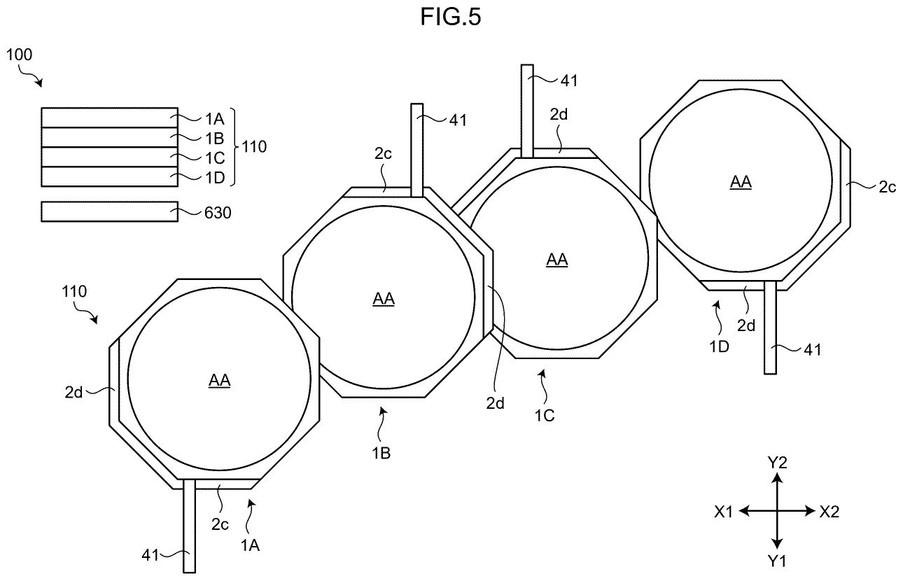

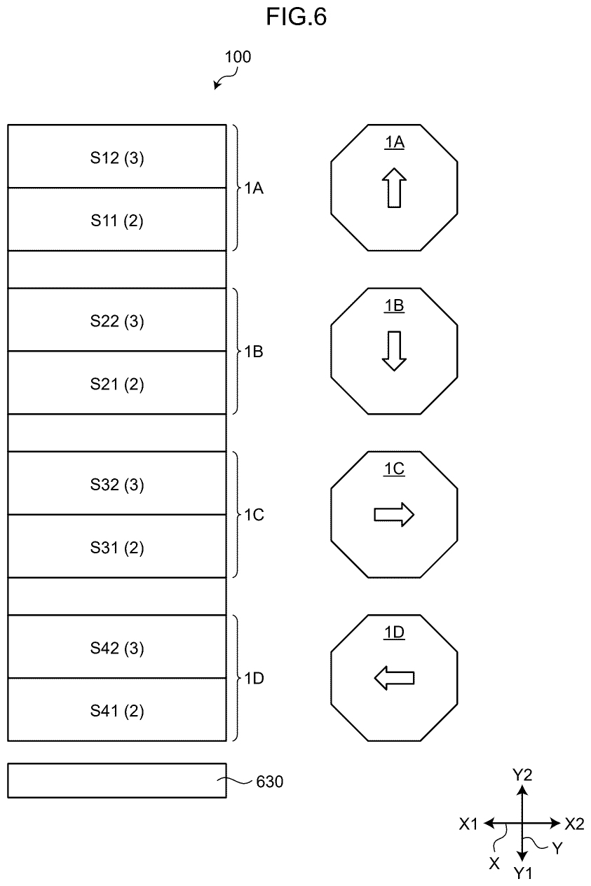

The following briefly describes the configuration of a light adjustment device 100 according to the first embodiment. FIG. 5 is a schematic diagram of four light adjustment panels constituting the light adjustment device according to the first embodiment. FIG. 6 is a schematic diagram illustrating an arrangement of the four light adjustment panels in a panel unit.

As illustrated in FIGS. 5 and 6, the light adjustment device 100 includes a light source 630 and a panel unit 110. The light source 630 is positioned on the lower side (Z2 side) relative to the panel unit 110. In the panel unit 110, a first light adjustment panel 1A, a second light adjustment panel 1B, a third light adjustment panel 1C, and a fourth light adjustment panel 1D are stacked in this order from the upper side. The number of light adjustment panels 1 included in the light adjustment device 100 is not limited to four but may be two or more.

As illustrated in FIG. 6, the first light adjustment panel 1A includes a first substrate S11 (first substrate 2) and a second substrate S12 (second substrate 3) stacked on the upper side (Z1 side) relative to the first substrate S11. The second light adjustment panel 1B includes a first substrate S21 (first substrate 2) and a second substrate S22 (second substrate 3) stacked on the upper side (Z1 side) relative to the first substrate S21. The third light adjustment panel 1C includes a first substrate S31 (first substrate 2) and a second substrate S32 (second substrate 3) stacked on the upper side (Z1 side) relative to the first substrate S31. The fourth light adjustment panel 1D includes a first substrate S41 (first substrate 2) and a second substrate S42 (second substrate 3) stacked on the upper side (Z1 side) relative to the first substrate S41.

As illustrated in FIG. 5, in the first light adjustment panel 1A, the first terminal group 10 (refer to FIG. 4) provided at the end part 2c of the first substrate S11 (first substrate 2) is positioned on the Y1 side and electrically coupled to a flexible printed circuit board 41.

As illustrated in FIGS. 5 and 6, the second light adjustment panel 1B is obtained by rotating the first light adjustment panel 1A by 180° in the clockwise direction in plan view. Accordingly, the first terminal group 10 is positioned on the Y2 side and electrically coupled to a flexible printed circuit board 41. The third light adjustment panel 1C is obtained by rotating the first light adjustment panel 1A by 90° in the clockwise direction in plan view, and the second terminal group 20 provided at the end part 2d is positioned on the Y2 side and electrically coupled to a flexible printed circuit board 41. The fourth light adjustment panel 1D is obtained by rotating the first light adjustment panel 1A by 270° in the clockwise direction in plan view, and the second terminal group 20 provided at the end part 2d is positioned on the Y1 side and electrically coupled to a flexible printed circuit board 41.

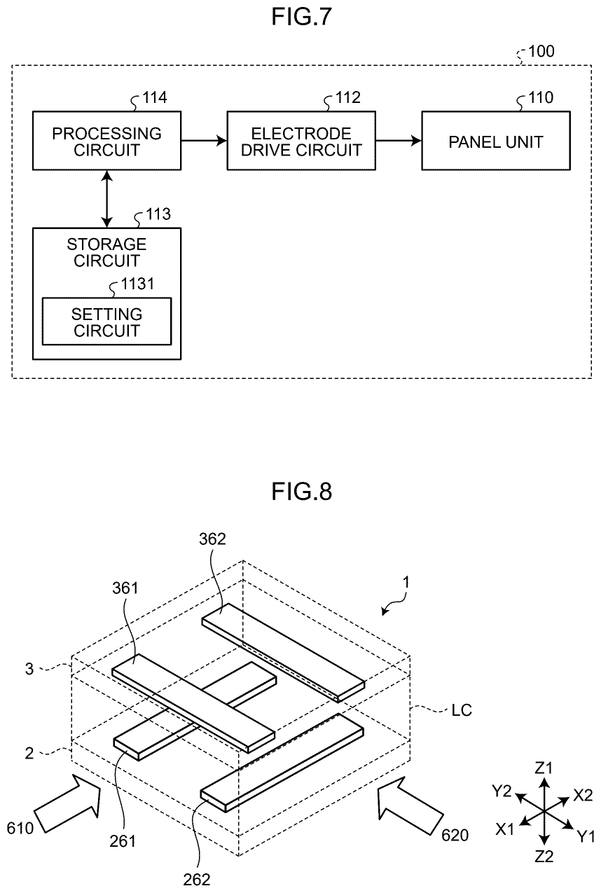

The following describes a block diagram of the light adjustment device 100. FIG. 7 is a block diagram of the light adjustment device. As illustrated in FIG. 7, the light adjustment device 100 according to the first embodiment includes, as a control block for controlling the panel unit 110, an electrode drive circuit 112, a storage circuit 113, and a processing circuit 114. The processing circuit 114 is constituted by a microcomputer for executing light distribution control and light adjustment control of the light adjustment device 100. The processing circuit 114 is a driver electrically coupled to each of the light adjustment panels 1 and configured to control voltage applied to each of the light adjustment panels 1.

The electrode drive circuit 112 supplies voltage to the drive electrodes 261, 262, 361, and 362 of each light adjustment panel 1 of the panel unit 110 based on the result of processing at the processing circuit 114.

The storage circuit 113 includes, for example, an internal memory mounted in the microcomputer constituting the processing circuit 114. A storage region of the storage circuit 113 temporarily stores intermediate data of processing at the processing circuit 114.

The storage circuit 113 further includes a setting circuit 1131. The setting circuit 1131 sets settings such as the frequency and phase of voltage supplied to the drive electrodes 261, 262, 361, and 362 of each light adjustment panel 1. The setting circuit 1131 is, for example, a dual in-line package switch (DIP switch) with which each setting can be set. In this case, the setting circuit 1131 has, for example, a configuration including a plurality of switch circuits with two states of “0” and “1”.

The following describes operation modes for general light diffusion. FIG. 8 is a schematic perspective view of each light adjustment panel, illustrating an arrangement of the drive electrodes. As illustrated in FIG. 8, each light adjustment panel 1 includes the first substrate 2, the drive electrodes 261 and 262 provided on the first substrate 2, the second substrate 3, the drive electrodes 361 and 362 provided on the second substrate 3, and a liquid crystal layer LC disposed between the first substrate 2 and the second substrate 3.

As illustrated in FIG. 8, the drive electrodes 261 and 262 and the drive electrodes 361 and 362 are pairs of electrodes disposed with the liquid crystal layer LC interposed therebetween.

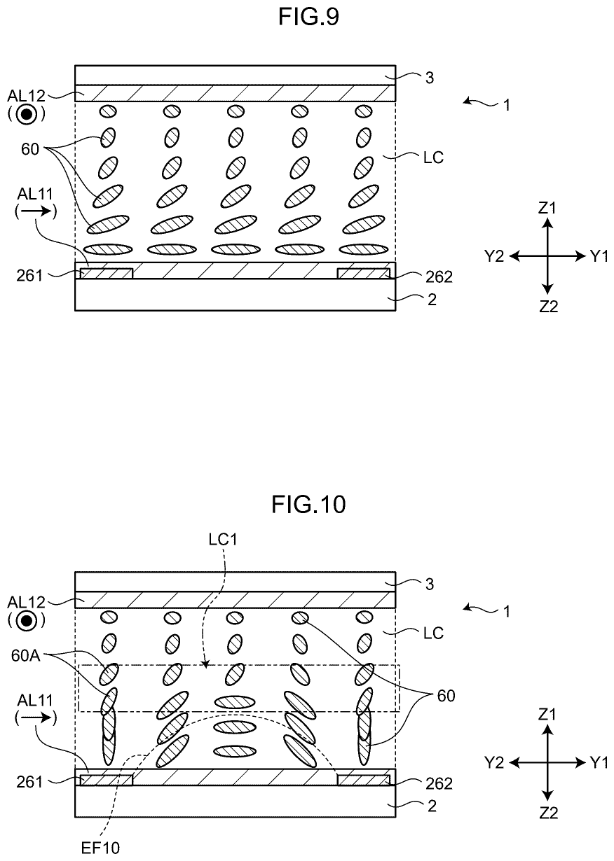

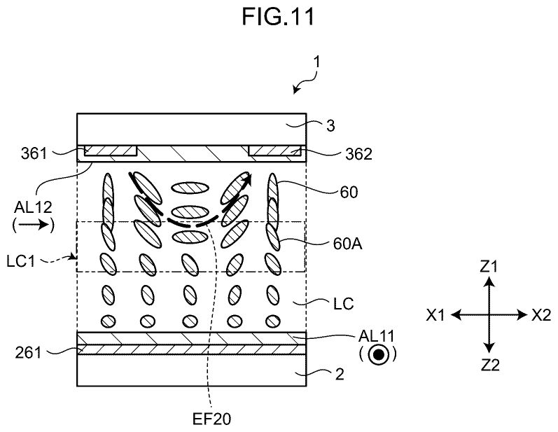

FIG. 9 is a sectional view of each light adjustment panel, illustrating the alignment state of liquid crystal molecules in a state in which no voltage is applied to the drive electrodes on the first substrate side. FIG. 10 is a sectional view of each light adjustment panel, illustrating the alignment state of liquid crystal molecules when voltage is applied to the drive electrodes on the first substrate side. FIG. 11 is a sectional view of each light adjustment panel, illustrating the alignment state of liquid crystal molecules when voltage is applied to the drive electrodes on the second substrate side. FIGS. 9 and 10 are views of the light adjustment panel along the direction of arrow 610 in FIG. 8, and FIG. 11 is a view of the light adjustment panel along the direction of arrow 620 in FIG. 8.

A first alignment film AL11 is formed on the drive electrodes 261 and 262 as illustrated in FIG. 9, and a second alignment film AL12 is formed on the drive electrodes 361 and 362 as illustrated in FIG. 11. The liquid crystal layer LC is filled between the first substrate 2 and the second substrate 3. As illustrated in FIG. 10, a central part of the liquid crystal layer LC in the Z direction is an intermediate layer LC1. The liquid crystal layer LC contains a plurality of liquid crystal molecules 60. Among the liquid crystal molecules 60, liquid crystal molecules 60 disposed in the intermediate layer LC1 are referred to as liquid crystal molecules 60A.

FIG. 9 illustrates a configuration in which the alignment treatment direction of the first alignment film AL11 and the alignment treatment direction of the second alignment film AL12 are different from each other in each light adjustment panel 1. Specifically, the first alignment film AL11 is subjected to alignment treatment in the Y direction, and the second alignment film AL12 is subjected to alignment treatment in the X direction. In this manner, the alignment direction of the first alignment film AL11 and the alignment direction of the second alignment film AL12 are substantially orthogonal to each other when viewed in the Z direction. Accordingly, the initial light distribution direction the first substrate 2 side is orthogonal to (intersects) the initial light distribution direction on the second substrate 3 side when viewed in the Z direction. The alignment treatment may be rubbing treatment or optical alignment treatment. The alignment direction of each alignment film may be set in the range of 90°±10° relative to the extending direction of the drive electrodes.

Since the alignment direction of the first alignment film AL11 and the alignment direction of the second alignment film AL12 are substantially orthogonal to each other, the liquid crystal molecules 60 in the liquid crystal layer LC are subjected to such alignment that the long-axis directions of the liquid crystal molecules 60 are twisted by 90° from the first alignment film AL11 to the second alignment film AL12 without receiving effects of external electric field. Since FIG. 9 illustrates the state in which no voltage is applied to the drive electrodes 261 and 262, the long-axis directions of the liquid crystal molecules 60 is aligned with a twist by 90° from the first alignment film AL11 to the second alignment film AL12 as illustrated in FIG. 9.

Specifically, the initial alignment directions of the liquid crystal molecules 60 in the liquid crystal layer LC (alignment of the long-axis directions of the liquid crystal molecules) gradually rotate from the first substrate 2 side toward the second substrate 3 side, ultimately rotating by 90°. Upon electric field generation between adjacent electrodes of the substrates, the liquid crystal molecules rotate their orientations from the initial alignment directions toward directions in accordance with the electric field direction, whereby, refractive index distribution of light is generated in the liquid crystal layer LC.

FIG. 9 illustrates an example in which a positive-type twisted nematic liquid crystal (TN liquid crystal) is used as the liquid crystal layer LC and the long axes of the liquid crystal molecules 60 are aligned in the same directions as the alignment directions of the alignment films. The liquid crystal layer LC preferably contains a chiral agent that applies twist to the liquid crystal molecules 60.

For example, when voltage that is alternately switched between a low-level voltage and a high-level voltage periodically is applied to the drive electrodes 261 and 262, an electric field EF10 (electric field) illustrated with a dashed line is generated between the drive electrodes 261 and 262 as illustrated in FIG. 10. As illustrated in FIG. 10, the alignment directions of the liquid crystal molecules 60 on the first substrate 2 side change due to influence of the electric field. For example, the alignment of the liquid crystal molecules 60 on the first substrate 2 side changes so that their long-axis direction match directions parallel to the directions of the electric field.

It is known that the refractive index of a liquid crystal changes with the alignment state. As illustrated in FIG. 9, in an OFF state in which no electric field acts on the liquid crystal layer LC, the long-axis directions of the liquid crystal molecules 60 are horizontally aligned along the front surface of each substrate and aligned with a twist by 90° from the first substrate 2 side to the second substrate 3 side. The liquid crystal layer LC in this alignment state has substantially uniform refractive index distribution. Thus, S-waves and P-waves of light incident on the light adjustment panel 1 that are orthogonal to each other are optically rotated due to influence of the initial alignment of the liquid crystal molecules 60 but are transmitted through the liquid crystal layer LC in the Z direction with little refraction (or scattering). The optical rotation refers to change in the polarization directions of polarized components during passing through the liquid crystal layer LC, and specifically, refers to change of the P-polarized component (P-waves) to the S-polarized component (S-waves) and change of the S-polarized component (S-waves) to the P-polarized component (P-waves) during passing through the liquid crystal layer LC.

As illustrated in FIG. 10, in an ON state in which voltage is applied to the drive electrodes 261 and 262 and the electric field EF10 is formed, the long axes of the liquid crystal molecules 60 are aligned with the electric field EF10 in a case where the liquid crystal layer LC has positive dielectric anisotropy. As a result, as illustrated in FIG. 10, for example, a region in which the liquid crystal molecules 60 stand substantially upright above the drive electrodes 261 and 262, a region in which the liquid crystal molecules 60 are obliquely aligned along with the distribution of the electric field EF10 between the drive electrodes 261 and 262, and a region that is separated from the drive electrodes 261 and 262 and in which the initial alignment state is maintained, are formed in the liquid crystal layer LC.

As illustrated in FIG. 10, between the drive electrodes 261 and 262, the long axes of the liquid crystal molecules 60 are aligned in a circular arc shape that is convex upward along a direction in which the electric field EF10 is generated. Accordingly, in view of the entire liquid crystal on the first substrate 2 side, the liquid crystal molecules 60 are aligned in a circular arc shape that is convex toward the upper side (Z1 side) between the drive electrodes 261 and 262. As a result, a dielectric constant distribution is formed in the liquid crystal layer LC, and incident light (polarized component parallel to the initial alignment direction of the liquid crystal molecules 60) radially diffuses.

As illustrated in FIG. 11, on the second substrate 3 side, in an ON state in which voltage is applied to the drive electrodes 361 and 362, and for example, an equipotential electric field EF20 in a circular arc shape that is convex downward is formed, the long axes of the liquid crystal molecules 60 are aligned with the electric field EF20 in a case where the liquid crystal layer LC has positive dielectric anisotropy. Specifically, between the drive electrodes 361 and 362, the long axes of the liquid crystal molecules 60 are aligned in a circular arc shape that is convex downward along a direction in which the electric field EF20 is generated. Accordingly, a polarized component included in incident light and parallel to the initial alignment direction of the liquid crystal molecules 60 on the second substrate 3 side radially diffuses by the drive electrodes 361 and 362. As a result, polarized light that diffuses the first substrate 2 side and polarized light that diffuses on the second substrate 3 side optically rotate and change their polarization directions when passing through the liquid crystal layer LC, and accordingly, the same polarized light is diffused.

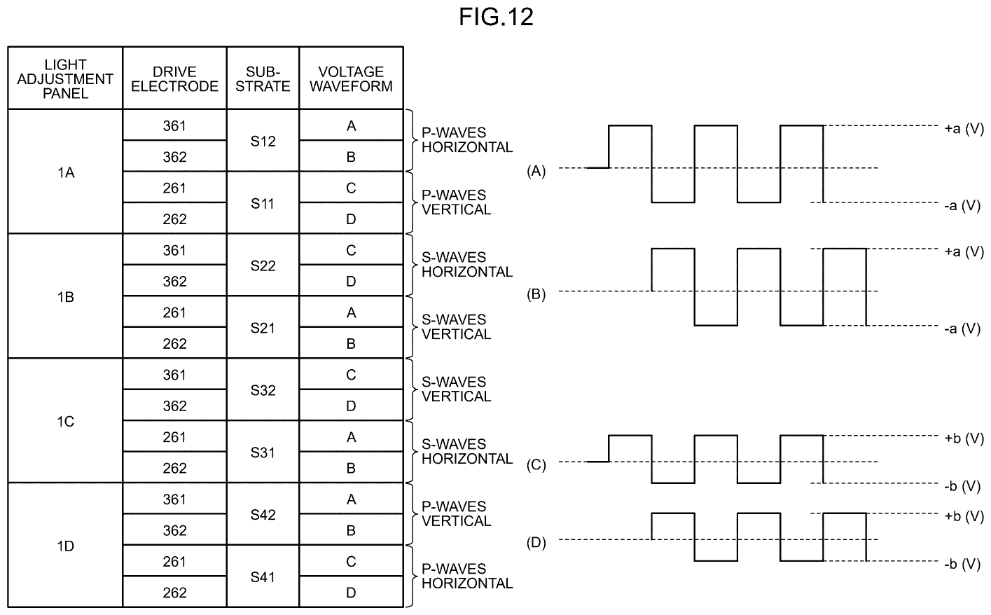

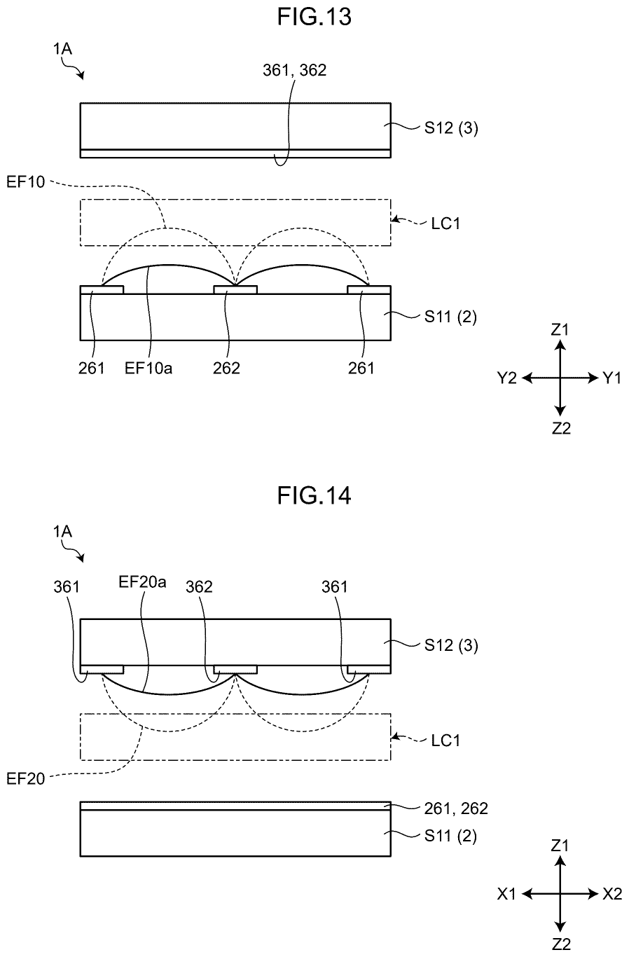

The following describes voltages applied to the drive electrodes on the first substrate side and the drive electrodes on the second substrate side. FIG. 12 is a diagram illustrating voltage waveforms input to the drive electrodes of each light adjustment panel. FIG. 13 is a schematic diagram illustrating a section of each light adjustment panel corresponding to FIG. 10, illustrating electric fields that are convex upward when voltage is applied to the drive electrodes on the first substrate side. FIG. 14 is a schematic diagram illustrating a section of each light adjustment panel corresponding to FIG. 11, illustrating electric fields that are convex downward when voltage is applied to the drive electrodes on the second substrate side.

As illustrated in FIG. 12, in each of the four stacked light adjustment panels 1, one of voltage applied to the drive electrodes 261 and 262 on the first substrate 2 side and voltage applied to the drive electrodes 361 and 362 on the second substrate 3 side is a “predetermined highest voltage”, and the other voltage is a “voltage less than the predetermined highest voltage”. Specifically, in the first embodiment, “a” (V) is the “predetermined highest voltage”, and “b” (V) is the “voltage less than the predetermined highest voltage”. Detailed description is given below.

As illustrated in FIG. 12, in the first light adjustment panel 1A, voltage with a voltage waveform C is applied to the drive electrodes 261 on the first substrate S11 side, and voltage with a voltage waveform D is applied to the drive electrodes 262. In the voltage waveforms C and D, the high-level voltage is (+b V), and the low-level voltage is (−b V). In other words, pulse voltages having the same amplitude and opposite polarities to each other within the same period are applied to the drive electrodes 261 and 262, respectively, on the first substrate S11 side. At the drive electrodes 261 and 262 on the first substrate S11 side, P-waves at light incidence diffuse in the vertical direction.

In the first light adjustment panel 1A, voltage with a voltage waveform A is applied to the drive electrodes 361 on the second substrate S12 side, and voltage with a voltage waveform B is applied to the drive electrodes 362. In the voltage waveforms A and B, the high-level voltage is (+a V), and the low-level voltage is (−a V). Voltage “a” (V) is higher than voltage “b” (V). Voltage “a” (V) is, for example, 7.5 V, and voltage “b” (V) is, for example, 3 V. In this manner, pulse voltages having the same amplitude and opposite polarities to each other within the same period are applied to the drive electrodes 361 and 362, respectively, on the second substrate S12 side. At the drive electrodes 361 and 362 on the second substrate S12 side, P-waves at light incidence diffuse in the horizontal direction. As described above, “a” V is the predetermined highest voltage (7.5 V), and “b” V is the voltage (3 V) less than the predetermined highest voltage. Thus, in the first light adjustment panel 1A, voltage applied to the drive electrodes 361 and 362 on the second substrate S12 side is the “predetermined highest voltage”. The “predetermined highest voltage” is, for example, “a” V (7.5 V), but other voltage depending on various conditions such as panel specifications may be employed as appropriate.

As illustrated in FIG. 12, in the second light adjustment panel 1B, voltage with the voltage waveform A is applied to the drive electrodes 261 on the first substrate S21 side, and voltage with the voltage waveform B is applied to the drive electrodes 262. In the voltage waveforms A and B, the high-level voltage is (+a V), and the low-level voltage is (−a V). At the drive electrodes 261 and 262 on the first substrate S21 side, S-waves at light incidence diffuse in the vertical direction.

In the second light adjustment panel 1B, voltage with the voltage waveform C is applied to the drive electrodes 361 on the second substrate S22 side, and voltage with the voltage waveform D is applied to the drive electrodes 362. In the voltage waveforms C and D, the high-level voltage is (+b V), and the low-level voltage is (−b V). At the drive electrodes 361 and 362 on the second substrate S22 side, S-waves at light incidence diffuse in the horizontal direction. In the second light adjustment panel 1B, voltage applied to the drive electrodes 261 and 262 on the first substrate S21 side is the “predetermined highest voltage”.

As illustrated in FIG. 12, in the third light adjustment panel 1C, voltage with the voltage waveform A is applied to the drive electrodes 261 on the first substrate S31 side, and voltage with the voltage waveform B is applied to the drive electrodes 262. In the voltage waveforms A and B, the high-level voltage is (+a V), and the low-level voltage is (−a V). At the drive electrodes 261 and 262 on the first substrate S31 side, S-waves at light incidence diffuse in the horizontal direction.

In the third light adjustment panel 1C, voltage with the voltage waveform C is applied to the drive electrodes 361 on the second substrate S32 side, and voltage with the voltage waveform D is applied to the drive electrodes 362. In the voltage waveforms C and D, the high-level voltage is (+b V), and the low-level voltage is (−b V). At the drive electrodes 361 and 362 on the second substrate S32 side, S-waves at light incidence diffuse in the vertical direction. In the third light adjustment panel 1C, voltage applied to the drive electrodes 261 and 262 on the first substrate S31 side is the “predetermined highest voltage”.

As illustrated in FIG. 12, in the fourth light adjustment panel 1D, voltage with the voltage waveform C is applied to the drive electrodes 261 on the first substrate S41 side, and voltage with the voltage waveform D is applied to the drive electrodes 262. In the voltage waveforms C and D, the high-level voltage is (+b V), and the low-level voltage is (−b V). At the drive electrodes 261 and 262 on the first substrate S41 side, P-waves at light incidence diffuse in the horizontal direction.

In the fourth light adjustment panel 1D, voltage with the voltage waveform A is applied to the drive electrodes 361 on the second substrate S42 side, and voltage with the voltage waveform B is applied to the drive electrodes 362. In the voltage waveforms A and B, the high-level voltage is (+a V), and the low-level voltage is (−a V). At the drive electrodes 361 and 362 on the second substrate S42 side, P-waves at light incidence diffuse in the vertical direction. In the fourth light adjustment panel 1D, voltage applied to the drive electrodes 361 and 362 on the second substrate S42 side is the “predetermined highest voltage”.

The following describes the extent of an electric field. As illustrated in FIG. 13, when the applied voltage is “a” (V), the electric field acting on the drive electrodes 261 and 262 is the electric field EF10 illustrated with a dashed line; whereas, when the applied voltage is “b” (V), the electric field acting on the drive electrodes 261 and 262 is an electric field EF10a illustrated with a solid line.

As illustrated in FIG. 14, when the applied voltage is “a” (V), the electric field acting on the drive electrodes 361 and 362 is the electric field EF20 illustrated with a dashed line; whereas, when the applied voltage is “b” (V), the electric field acting on the drive electrodes 361 and 362 is an electric field EF20a illustrated with a solid line.

In summary, in the first light adjustment panel 1A, when the extent of an electric field at an applied voltage of “a” (v) is used as a reference, the extent of an electric field on the first substrate S11 side is that of the electric field EF10a smaller than the reference, and the extent of an electric field on the second substrate S12 side is that of the electric field EF20 same as the reference.

Similarly, in the second light adjustment panel 1B, when the extent of an electric field at an applied voltage of “a” (v) is used as a reference, the extent of an electric field on the first substrate S21 side is that of the electric field EF10 same as the reference, and the extent of an electric field on the second substrate S22 side is that of the electric field EF20a smaller than the reference.

In the third light adjustment panel 1C, when the extent of an electric field at an applied voltage of “a” (v) is used as a reference, the extent of an electric field on the first substrate S31 side is that of the electric field EF10 same as the reference, and the extent of an electric field on the second substrate S32 side is that of the electric field EF20a smaller than the reference.

In the fourth light adjustment panel 1D, when the extent of an electric field at an applied voltage of “a” (v) is used as a reference, the extent of an electric field on the first substrate S41 side is that of the electric field EF10a smaller than the reference, and the extent of an electric field on the second substrate S42 side is that of the electric field EF20 same as the reference.

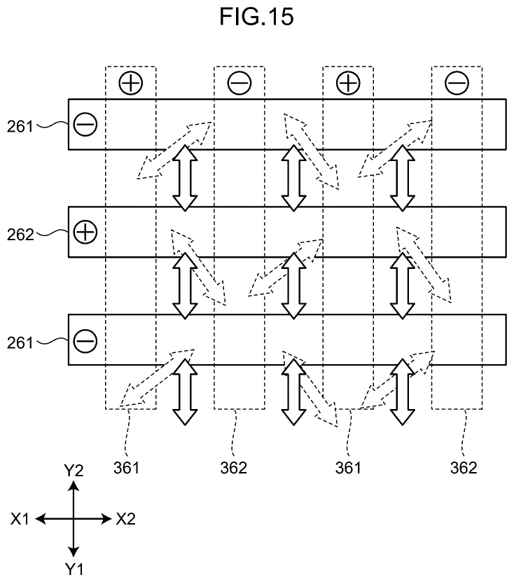

FIG. 15 is a diagram of each light adjustment panel when viewed from the upper side, illustrating the direction of an electric field at the central part of the liquid crystal layer in the thickness direction with arrows. In a case where voltage applied to the drive electrodes 261 and 262 is “a” (V) as the predetermined highest voltage, a region affected by the equipotential electric field EF10 in a circular arc shape that is convex toward the Z1 side (upper side) reaches a region of the intermediate layer LC1 as illustrated in FIG. 13. In a case where voltage applied to the drive electrodes 361 and 362 is “a” (V) as the predetermined highest voltage, a region affected by the electric field EF20 in a circular arc shape that is convex toward the Z2 side (lower side) reaches a region of the intermediate layer LC1 as illustrated in FIG. 14. In other words, in a case where voltage applied to the drive electrodes 261 and 262 and voltage applied to the drive electrodes 361 and 362 are both the highest voltage “a” (V), the region affected by the electric field EF10 due to the drive electrodes 261 and 262 and the region affected by the electric field EF20 due to the drive electrodes 361 and 362 intersect each other in a region of the intermediate layer LC1. Accordingly, as illustrated with dashed lines in FIG. 15, in the intermediate layer LC1, an electric field acts in oblique directions intersecting both the X and Y directions.

However, as described with reference to FIG. 12, in a case where one of an electric field acting on the first substrate 2 side and an electric field acting on the second substrate 3 side is the predetermined highest voltage (“a” V) and the other electric field is the voltage (“b” V) less than the predetermined highest voltage, the region affected by the electric field EF10 and the region affected by the electric field EF20a are less likely to intersect each other in a region of the intermediate layer LC1. Accordingly, as illustrated with solid arrows in FIG. 15, in the first embodiment, an electric field acts, for example, in a direction substantially orthogonal to the drive electrodes 261 and 262 in a region of the intermediate layer LC1.

In the light adjustment device 100 according to the first embodiment, the diffusion degree in the vertical direction and the diffusion degree in the horizontal direction are the same, and accordingly, light output from the panel unit has what is called a vertical-horizontal diffusion shape extending in both the vertical and horizontal directions.

As described above, the light adjustment device 100 according to the first embodiment includes the panel unit 110, the light source 630, and the processing circuit 114 (driver). Each of the light adjustment panels includes the first substrate 2, the second substrate 3, and the liquid crystal layer LC. In a case where one of voltage supplied to the electrodes provided on the first substrate 2 and voltage supplied to the electrodes provided on the second substrate 3 is the predetermined highest voltage (“a” V), the other voltage is the voltage (“b” V) less than the predetermined highest voltage.

As described above, in the light adjustment device according to JP-A-2010-230887, when voltage applied to the upper and lower drive electrodes is increased, the upper and lower electrical field intersect each other at the intermediate part of the liquid crystal layer in the thickness direction. Accordingly, alignment disorder may occur to liquid crystal molecules disposed at the intermediate part of the liquid crystal layer in the thickness direction, thereby causing unintended diffusion and potentially leading to decrease in the illuminance of light emitted from the panel unit of the light adjustment device.

However, in the first embodiment, in a case where one of voltage supplied to the electrodes provided on the first substrate 2 and voltage supplied to the electrodes provided on the second substrate 3 is the predetermined highest voltage (“a” V), the other voltage is the voltage (“b” V) less than the predetermined highest voltage. Accordingly, intersection of the upper and lower electric fields is further reduced in the intermediate layer LC1 of the liquid crystal layer LC in the thickness direction, and as a result, alignment disorder is less likely to occur to the liquid crystal molecules 60A disposed in the intermediate layer LC1, and occurrence of unintended diffusion is reduced. Consequently, decrease in the illuminance of light emitted from the panel unit 110 of the light adjustment device 100 is inhibited.

The electrodes provided on the first substrate 2 include the first drive electrodes 261 and the second drive electrodes 262 disposed adjacent to the first drive electrodes 261, and the electrodes provided on the second substrate 3 include the third drive electrodes 361 and the fourth drive electrodes 362 disposed adjacent to the third drive electrodes 361.

Thus, pulse voltages having the same amplitude and opposite polarities to each other within the same period can be easily applied to the first and second drive electrodes 261 and 262 and the third and fourth drive electrodes 361 and 362.

### Second Embodiment

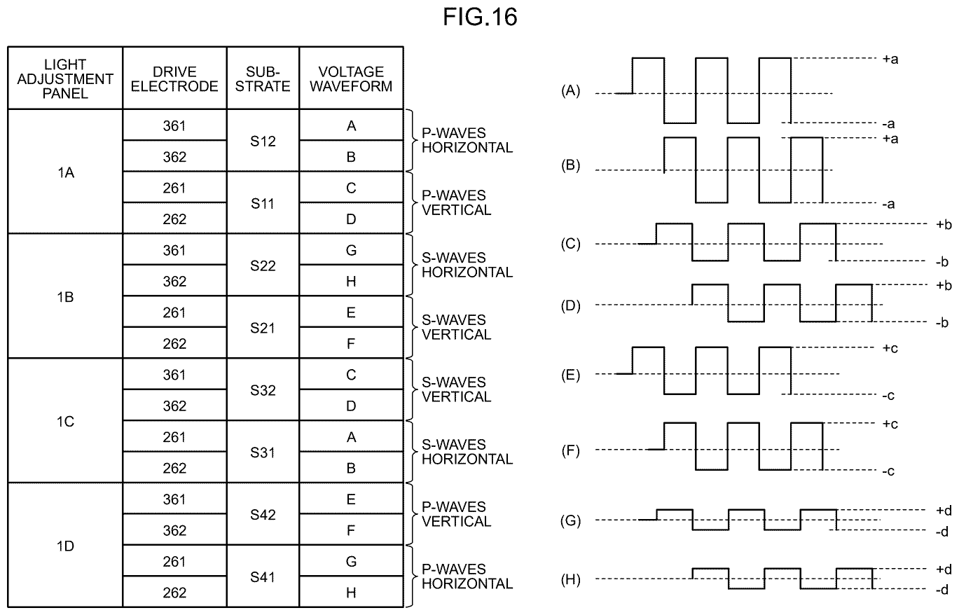

The following describes a second embodiment. Voltage applied to drive electrodes has two heights (“a” V and “b” V) in the first embodiment, but has four heights (“a” V, “b” V, “c” V, and “d” V) in the second embodiment. FIG. 16 is a diagram illustrating voltage waveforms input to the drive electrodes of each light adjustment panel in the second embodiment. In the second embodiment, the four light adjustment panels include a first-type light adjustment panel and a second-type light adjustment panel. In the first-type light adjustment panel, in a case where one of voltage supplied to the electrodes provided on the first substrate 2 and voltage supplied to the electrodes provided on the second substrate 3 is a “predetermined highest voltage”, the other voltage is a “voltage less than the predetermined highest voltage”. In the second-type light adjustment panel, in a case where one of voltage supplied to the electrodes provided on the first substrate 2 and voltage supplied to the electrodes provided on the second substrate 3 is “voltage corresponding to a predetermined high voltage range”, the other voltage is “voltage lower than the lower limit of the predetermined high voltage range”. Specifically, in the second embodiment, each of the first light adjustment panel 1A and the third light adjustment panel 1C is the “first-type light adjustment panel”, and each of the second light adjustment panel 1B and the fourth light adjustment panel 1D is the “second-type light adjustment panel”. For example, the “predetermined highest voltage” is “a” V (7.5 V). For example, the “predetermined high voltage range” is, for example, a range of “c” V or more and “a” V or less. For example, “a” V is 7.5 V, “b” V is 3 V, “c” V is 5 V, and “d” V is 1 V. Accordingly, the “predetermined high voltage range” is, for example, a range of 5 V or more and 7.5 V or less. The following description will be mainly made on different points from the first embodiment.

As illustrated in FIG. 16, in the first light adjustment panel 1A, voltage applied to the drive electrodes 261 and 262 on the first substrate 2 side and voltage applied to the drive electrodes 361 and 362 on the second substrate 3 side are the same as in the first embodiment.

Specifically, in the first light adjustment panel 1A, voltage with the voltage waveform C is applied to the drive electrodes 261 on the first substrate S11 side, and voltage with the voltage waveform D is applied to the drive electrodes 262. In the voltage waveforms C and D, the high-level voltage is (+b V), and the low-level voltage is (−b V). In the first light adjustment panel 1A, voltage with the voltage waveform A is applied to the drive electrodes 361 on the second substrate S12 side, and voltage with the voltage waveform B is applied to the drive electrodes 362. In the voltage waveforms A and B, the high-level voltage is (+a V), and the low-level voltage is (−a V). The voltage “a” V is the “predetermined highest voltage”. Since “b” V is less than “a” V, the voltage “b” V is the “voltage less than the predetermined highest voltage”.

In the second light adjustment panel 1B, voltage with a voltage waveform E is applied to the drive electrodes 261 on the first substrate S21 side, and voltage with a voltage waveform F is applied to the drive electrodes 262. In the voltage waveforms E and F, the high-level voltage is (+c V), and the low-level voltage is (−c V). In other words, pulse voltages having the same amplitude and opposite polarities to each other within the same period are applied to the drive electrodes 261 and 262, respectively, on the first substrate S21 side.

In the second light adjustment panel 1B, voltage with a voltage waveform G is applied to the drive electrodes 361 on the second substrate S22 side, and voltage with a voltage waveform H is applied to the drive electrodes 362. In the voltage waveforms G and H, the high-level voltage is (+d V), and the low-level voltage is (−d V). In other words, pulse voltages having the same amplitude and opposite polarities to each other within the same period are applied to the drive electrodes 361 and 362, respectively, on the second substrate S22 side. Moreover, “c” V is greater than “d” V, and “a” V is greater than “c” V. Thus, in the second light adjustment panel 1B according to the second embodiment, “c” V (5 V) is the “voltage corresponding to a predetermined high voltage range”. In addition, “d” V (1 V) is the “voltage lower than the lower limit of the predetermined high voltage range”.

In the third light adjustment panel 1C, voltage with the voltage waveform A is applied to the drive electrodes 261 on the first substrate S31 side, and voltage with the voltage waveform B is applied to the drive electrodes 262. In addition, voltage with the voltage waveform C is applied to the drive electrodes 361 on the second substrate S32 side, and voltage with the voltage waveform D is applied to the drive electrodes 362. Accordingly, in the third light adjustment panel 1C according to the second embodiment, “a” V (7.5 V) is the “predetermined highest voltage”. In addition, “b” V (3 V) is the “voltage less than the predetermined highest voltage”.

In the fourth light adjustment panel 1D, voltage with the voltage waveform G is applied to the drive electrodes 261 on the first substrate S41 side, and voltage with the voltage waveform H is applied to the drive electrodes 262. In addition, voltage with the voltage waveform E is applied to the drive electrodes 361 on the second substrate S42 side, and voltage with the voltage waveform F is applied to the drive electrodes 362. Accordingly, in the fourth light adjustment panel 1D according to the second embodiment, “c” V (5 V) is the “voltage corresponding to a predetermined high voltage range”. In addition, “d” V (1 V) is the “voltage lower than the lower limit of the predetermined high voltage range”.

In the light adjustment device according to the second embodiment, since “a” V is greater than “c” V, the diffusion degree in the horizontal direction is larger than the diffusion degree in the vertical direction. Thus, light output from the panel unit 110 has an elliptical shape that is long in the horizontal direction. In the second embodiment, “a” V is greater than “b” V, “c” V is greater than “d”V, and “a”V is greater than “c”V.

As a modification, for example, in the fourth light adjustment panel 1D, voltage with the voltage waveform G may be applied to the drive electrodes 261 on the first substrate S41 side, voltage with the voltage waveform H may be applied to the drive electrodes 262, voltage with the voltage waveform G may be applied to the drive electrodes 361 on the second substrate S42 side, and voltage with the voltage waveform H may be applied to the drive electrodes 362. With this configuration, as illustrated in FIG. 13, a region affected by an electric field due to the drive electrodes on the first substrate side and a region affected by an electric field due to the drive electrodes on the second substrate side are further less likely to intersect each other in a region of the intermediate layer LC1.

As described above, in the second embodiment, the light adjustment panels include the “first-type light adjustment panel” and the “second-type light adjustment panel”. In the first-type light adjustment panel, in a case where one of voltage supplied to the electrodes provided on the first substrate 2 and voltage supplied to the electrodes provided on the second substrate 3 is the “predetermined highest voltage (“a” V)”, the other voltage is the “voltage (“b” V) less than the predetermined highest voltage”. In the second-type light adjustment panel, in a case where one of voltage supplied to the electrodes provided on the first substrate 2 and voltage supplied to the electrodes provided on the second substrate 3 is the “voltage (“c” V) corresponding to a predetermined high voltage range”, the other voltage is the “voltage (“d” V) lower than the lower limit of the predetermined high voltage range”. Accordingly, in the second embodiment as well, intersection of the upper and lower electric fields is further reduced in the intermediate layer LC1 of the liquid crystal layer LC in the thickness direction, as a result, alignment disorder is less likely to occur to the liquid crystal molecules 60A disposed in the intermediate layer LC1, and occurrence of unintended diffusion is reduced. Consequently, decrease in the illuminance of light emitted from the panel unit of the light adjustment device is inhibited.

What is claimed is:

1. A light adjustment device comprising:
a panel unit in which a plurality of light adjustment panels are stacked in a first direction;
a light source disposed on one side in the first direction relative to the panel unit; and
a driver electrically coupled to each of the light adjustment panels and configured to control voltage applied to each of the light adjustment panels, wherein
each of the light adjustment panels provided in the panel unit includes
a first substrate provided with electrodes,
a second substrate placed in the first direction so as to overlap the first substrate and provided with electrodes, and
a liquid crystal layer filled between the first substrate and the second substrate, and
when one of voltage supplied to the electrodes provided on the first substrate and voltage supplied to the electrodes provided on the second substrate is a predetermined highest voltage, the other voltage is a voltage less than the predetermined highest voltage.

2. The light adjustment device according to claim 1, wherein
the electrodes provided on the first substrate include a first drive electrode and a second drive electrode disposed adjacent to the first drive electrode, and
the electrodes provided on the second substrate include a third drive electrode and a fourth drive electrode disposed adjacent to the third drive electrode.

3. A light adjustment device comprising:
a panel unit in which a plurality of light adjustment panels are stacked in a first direction;
a light source disposed on one side in the first direction relative to the panel unit; and
a driver electrically coupled to each of the light adjustment panels and configured to control voltage applied to each of the light adjustment panels, wherein
each of the light adjustment panels provided in the panel unit includes
a first substrate provided with electrodes,
a second substrate placed in the first direction so as to overlap the first substrate and provided with electrodes, and
a liquid crystal layer filled between the first substrate and the second substrate,
the light adjustment panels include a first-type light adjustment panel and a second-type light adjustment panel,
in the first-type light adjustment panel, when one of voltage supplied to the electrodes provided on the first substrate and voltage supplied to the electrodes provided on the second substrate is a predetermined highest voltage, the other voltage is a voltage less than the predetermined highest voltage, and
in the second-type light adjustment panel, in a case where one of voltage supplied to the electrodes provided on the first substrate and voltage supplied to the electrodes provided on the second substrate is voltage corresponding to a predetermined high voltage range, the other voltage is voltage lower than a lower limit of the predetermined high voltage range.

4. The light adjustment device according to claim 3, wherein
the electrodes provided on the first substrate include a first drive electrode and a second drive electrode disposed adjacent to the first drive electrode, and
the electrodes provided on the second substrate include a third drive electrode and a fourth drive electrode disposed adjacent to the third drive electrode.
